(19) United States
(12) Patent Application Publication
(10) Pub. No.: US 2004/0124633 A1
(43) Pub. Date: Jul. 1, 2004

(54) Structure for coupling fitting for hose assembly

(75) Inventor: Young Bok Song, Changwon (KR)

Correspondence Address: Ladas & Parry, 26 West 61st Street, New York, NY, 10023, US

(73) Assignee: VOLVO CONSTRUCTION EQUIPMENT HOLDING SWEDEN AB

(21) Appl. No.: 10/449,642

(22) Filed: May 29, 2003

(30) Foreign Application Priority Data
Dec. 30, 2002 (KR) 10-2002-0086296

(51) Int. Cl. F16L 33/00; F16L 47/00; F16L 49/00

(52) U.S. Cl. 285/248

(57) ABSTRACT

The present invention relates to a structure for coupling a fitting for a hose assembly in which an assistant nut having one end engaged with a relative part adapted to supply a certain fluid using a rotatably supported nut and the other end used when engaging a coupling for a connection with a hose is detachably threaded to the fitting. In a structure for coupling a fitting for a hose assembly which includes a cylindrical hollow fitting which has an engaging jaw in one end of the same and through which a certain fluid such as a gas flows, a nut which has one end rotatably supported by the engaging jaw and the other end engaged with a relative part for supplying fluid, and a coupling which fixedly pressurizes the hose inserted into the other end of the fitting in a radial direction, there is provided a structure for coupling a fitting for a hose assembly which comprises an assistant nut which is disposed between the fitting and the coupling and in which a female thread corresponding to a male thread formed in an outer wall of the fitting is formed in an inner wall, and a circular groove is formed in an outer wall for thereby fixing the coupling.

### BACKGROUND OF THE INVENTION

1. Field of the Invention

The present invention relates to a structure for coupling a fitting for a hose assembly which is capable of improving a fabrication ability in such a manner that a fitting engaged by a nut having an end rotatably supported by a relative part such as a valve adapted to supply a certain fluid and an assistant nut used for engaging a coupling for connecting a hose are detachably engaged by a thread method.

2. Description of the Background Art

FIG. 1 is a view illustrating a coupling structure of a fitting for a hose assembly in the conventional art.

As shown therein, a coupling structure of a fitting for a hose assembly includes a fitting 2 which includes a circular engaging jaw 1 formed in one side of an outer wall and a protruded portion 1a formed in the other side of an outer wall and formed in a hollow shape, a nut 3 which is rotatably supported by the engaging jaw 1 and is threaded with a relative part such as a valve adapted to supply a high pressure state fluid, a coupling 5 by which a hose 4 is fixed to the fitting 2 in such a manner that the hose 4 transferring a high pressure fluid is inserted into the protrusion 1a, and the hose 4 corresponding to the protrusion 1a is pressurized in a radial direction, and an assistant nut 6 which is disposed between the coupling 5 and the fitting 2 in order for the coupling 5 to be easily fixed to the fitting 2 and has a circular groove in an outer wall and is engaged with an end of the coupling 5 in a circular shape.

The operation of the conventional art will be described.

In order to fix the coupling 5 to an outer surface of the fitting 2, the nut 3 is inserted into the fitting 2. Thereafter, the assistant nut 6 and the coupling 5 are assembled. The assistant nut 6 that the nut 3 is inserted and the coupling is engaged is inserted into the fitting 2. Lastly, an outer portion of the fitting 2 contacting with the assistant nut 6 is fixed by a welding method or the assistant nut 6 is pressurized in a radial direction, and the assistant nut 6 is pressurized to an outer surface of the fitting 2.

However, the structure for coupling a fitting for a hose assembly in the conventional art has the following problems. In the case that the assistant nut 6 is fixed to the fitting 2 by a welding method, the fitting 2 is processed, and the assistant nut 6 is welded to an outer portion of the fitting 2. In addition to that, after the assistant nut 6 is welded, an annealing process for preventing a treat transformation is additionally performed.

Therefore, a workability is significantly decreased. In addition, in the case that a defect occurs during a welding process of the assistant nut 6, it is impossible to visually check the defect. Therefore, an inherent function of the assistant nut 6 may be lost, and a stability and reliability of the product are decreased.

In addition, in the case that the assistant nut 6 is pressurized in a radial direction and is fixed to the fitting 2, in order to implement a function of the assistant nut 6, a plastic transformation may occur in an outer surface of the fitting 2. When a plastic transformation occurs, a transformation may occur in an inner diameter side of the fitting 2. As the diameter is decreased, a high pressure state fluid may interfere the flow of the same. Therefore, it is impossible to implement an inherent function of the fitting 2. In addition, since a certain gap is formed between the fitting 2 and the assistant nut 6, an accurate fixing of the assistant nut 6 may not be implemented due to the gap. Therefore, the hose 4 may be escaped from the fitting 2 due to a high pressure fluid, so that it is impossible to implement a desired safety.

### SUMMARY OF THE INVENTION

Accordingly, it is an object of the present invention to provide a structure for coupling a fitting for a hose assembly which is capable of enhancing a fabrication ability in such a manner that an assistant nut used for connecting a hose to a fitting using a coupling is threaded to a fitting and implementing a reliability based on an accurate fixing of an assistant nut.

To achieve the above objects, in a structure for coupling a fitting for a hose assembly which includes a cylindrical hollow fitting which has an engaging jaw in one end of the same and through which a certain fluid such as a gas flows, a nut which has one end rotatably supported by the engaging jaw and the other end engaged with a relative part for supplying fluid, and a coupling which fixedly pressurizes the hose inserted into the other end of the fitting in a radial direction, there is provided a structure for coupling a fitting for a hose assembly which comprises an assistant nut which is disposed between the fitting and the coupling and in which a female thread corresponding to a male thread formed in an outer wall of the fitting is formed in an inner wall, and a circular groove is formed in an outer wall for thereby fixing the coupling.

The multi-step protrusion is formed in the other end of the fitting into which the hose is inserted in such a manner that the hose is not slipped in the fitting.

A circular collar corresponding to the circular groove is formed in an end of the coupling.

A multi-step protrusion is formed in an inner wall of the coupling for preventing the hose from being slipped in the coupling.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a structure for coupling a fitting for a hose assembly in the conventional art;

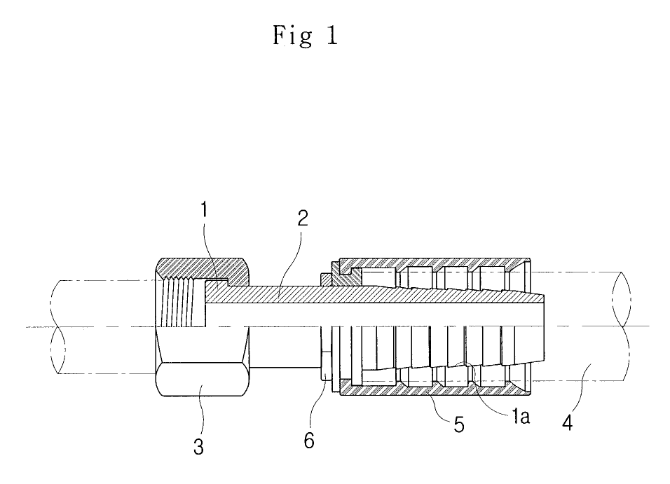

FIG. 2 is a separated perspective view illustrating a structure for coupling a fitting for a hose assembly according to the present invention;

FIG. 3 is an engagement cross sectional view illustrating a structure for coupling a fitting for a hose assembly according to the present invention; and

FIG. 4 is an engagement cross sectional view illustrating a state that a hose is connected in a structure for coupling a fitting for a hose assembly according to the present invention.

### DETAILED DESCRIPTION OF THE PREFERRED EMBODIMENTS

The structure for coupling a fitting of a hose assembly according to a preferred embodiment of the present invention will be described with reference to the accompanying drawings.

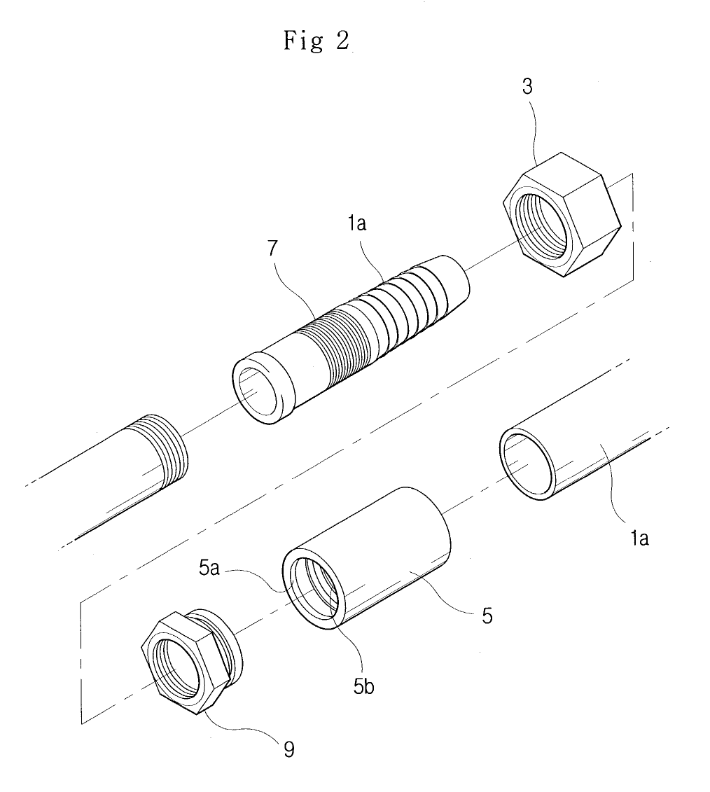

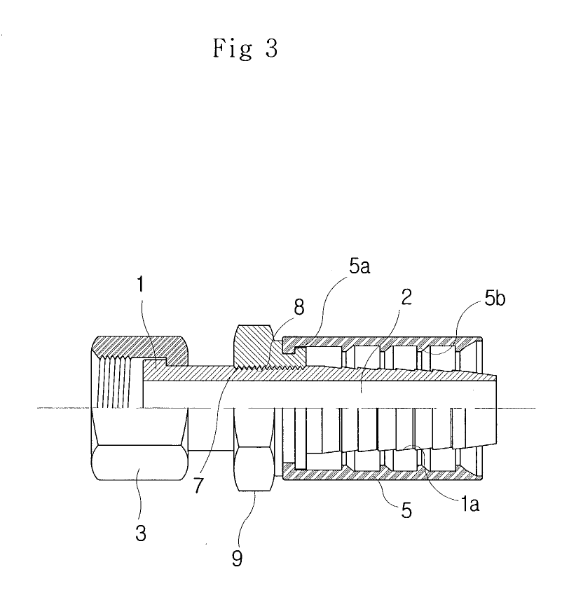

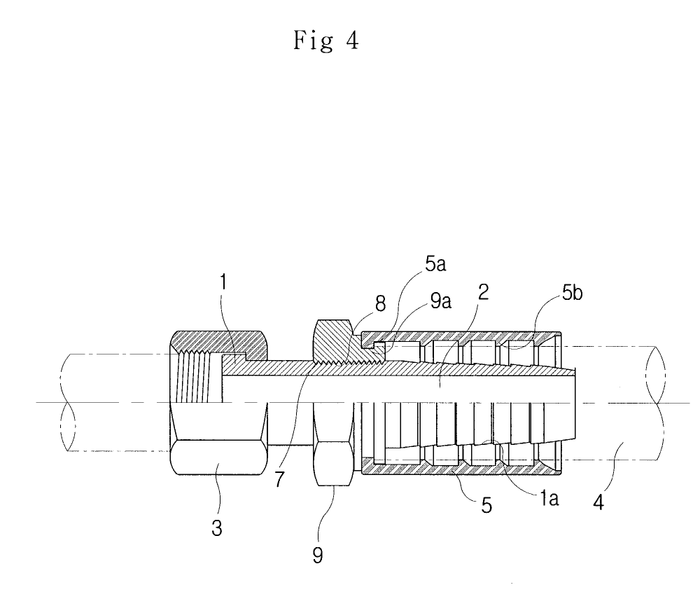

FIG. 2 is a separated perspective view illustrating a structure for coupling a fitting for a hose assembly according to the present invention, FIG. 3 is an engagement cross sectional view illustrating a structure for coupling a fitting for a hose assembly according to the present invention, and FIG. 4 is an engagement cross sectional view illustrating a state that a hose is connected in a structure for coupling a fitting for a hose assembly according to the present invention.

As shown therein, there are provided a fitting 1 in which a circular and hollow cylindrical engaging jaw 1 is formed in one side of an outer wall, a multi-step protrusion 1a is formed in the other side of an outer wall, and a male thread portion 7 is formed in an outer wall between the engaging jaw 1 and the protrusion 1a; a nut 3 which is rotatably supported by the engaging jaw 1 and is threaded with a relative part such as a valve for supplying a high pressure fluid; a coupling 5 in which a hose 4 is fixed to the fitting 2 in such a manner that the hose 4 which transfers a high pressure fluid is inserted into the protrusion 1a, and the hose 4 is fixed to the fitting 2; and an assistant nut 9 which is disposed between the coupling 5 and the fitting 2 in order for the coupling 5 to be easily fixed to the fitting 2 and has a female thread 8 formed in the inner wall and corresponding with the male thread 7 and which is thread-engaged with the fitting 2. The assistant nut 9 has a circular groove 9a in an outer wall for thereby being engaged with a circular collar 5a of the coupling 5. At this time, a protrusion 5b is formed in an inner wall of the coupling 5 in the same direction as the shape of the protrusion 1a for implementing a function in which the coupling 5 pressurizes the hose in a radial direction, and a slip prevention function in which the hose 4 is not slipped in the coupling 5.

The operation of the structure for coupling a fitting for a hose assembly according to the present invention will be described with reference to the accompanying drawings.

As shown in FIG. 4, the other end of the fitting 2 is inserted into the inner side of the nut 3 in order for one end of the fitting 2 to be engaged with the engaging jaw 1 and not to be escaped from the same. The circular collar 5a of the coupling 5 is assembled to the circular groove 9a of the assistant nut 9, and the other end of the fitting 2 is inserted into the inner side of the assistant nut 9 so that the female thread 8 of the assistant nut 9 is aligned with the male thread 7 of the fitting 2. The assistant nut 9 is continuously rotated in the clockwise direction, and the female thread 8 of the assistant nut 9 is engaged with the male thread 7 of the fitting 2, so that the assistant nut 9 and the fitting 2 are fixedly pressurized based on an assembling method.

As described above, in the present invention, the assistant nut is threaded to the fitting in such a manner that a female thread is formed in the assistant nut used when connecting the hose to the fitting using a coupling and a male thread is formed in the fitting, so that a welding process is cancelled, and the fabrication process is decreased. Since the fabrication and assembling process are simplified, the workability is significantly enhanced. In particular, since the assistant nut is accurately fixed to the fitting, it is possible to prevent a hose from being escaped from the fitting due to a high pressure fluid, so that a reliability and stability are implemented with respect to the products.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a structure for coupling a fitting for a hose assembly which includes a cylindrical hollow fitting which has an engaging jaw in one end of the same and through which a certain fluid such as a gas flows, a nut which has one end rotatably supported by the engaging jaw and the other end engaged with a relative part for supplying fluid, and a coupling which fixedly pressurizes the hose inserted into the other end of the fitting in a radial direction, a structure for coupling a fitting for a hose assembly, comprising:
an assistant nut which is disposed between the fitting and the coupling and in which a female thread corresponding to a male thread formed in an outer wall of the fitting is formed in an inner wall, and a circular groove is formed in an outer wall for thereby fixing the coupling.

2. The structure of claim 1, wherein said multi-step protrusion is formed in the other end of the fitting into which the hose is inserted in such a manner that the hose is not slipped in the fitting.

3. The structure of claim 1, wherein a circular collar corresponding to the circular groove is formed in an end of the coupling.

4. The structure of claim 1, wherein a multi-step protrusion is formed in an inner wall of the coupling for preventing the hose from being slipped in the coupling.
